(19) United States
(12) Patent Application Publication
(10) Pub. No.: US 2026/0151850 A1
(43) Pub. Date: Jun. 4, 2026

(54) APPARATUS FOR MOVING AN OPTICAL SYSTEM, AND LASER MACHINING DEVICE

(71) Applicant: TRUMPF Schweiz AG, Gruesch (CH)

(72) Inventors: Dirk Büche, Fanas (CH); Stephan Hugenschmidt, Schiers (CH)

(21) Appl. No.: 19/455,871

(22) Filed: Jan. 22, 2026

Related U.S. Application Data
(63) Continuation of application No. PCT/EP2024/071045, filed on Jul. 24, 2024.

(30) Foreign Application Priority Data
Jul. 27, 2023 (DE) 10 2023 119 914.5

(51) Int. Cl. B23K 26/064; B23K 26/38

(52) U.S. Cl. CPC B23K 26/0648; B23K 26/38

(57) ABSTRACT

An apparatus for moving an optical system includes a main body, a supporting body to which the optical system is attached, a drive, a first plate spring, and a second plate spring. The drive moves the supporting body relative to the main body along a longitudinal axis of the supporting body. The first plate spring is fastened, in an outer region, to the main body and, in an inner region, to a first side of the supporting body. The second plate spring is fastened, in an outer region, to the main body and, in an inner region, to a second side of the supporting body. The outer region and the inner region of the first plate spring and the outer region and the inner region of the second plate spring are each connected to one another via a plurality of arms which extend in the circumferential direction.

### CROSS REFERENCE TO RELATED APPLICATIONS

This application is a continuation of International Application No. PCT/EP2024/071045 (WO 2025/021886 A1), filed on Jul. 24, 2024, and claims benefit to German Patent Application No. DE 10 2023 119 914.5, filed on Jul. 27, 2023. The aforementioned applications are hereby incorporated by reference herein.

### FIELD

The present invention relates to an apparatus for moving an optical system and a laser machining device for machining a workpiece.

### BACKGROUND

Such an apparatus, in the form of a drive unit for a lens, is described in EP2099030A1.

The apparatus described above serves to move an optical system, for example in the form of a lens or a lens assembly, along a longitudinal axis of the supporting body. The longitudinal axis of the supporting body usually coincides with the optical axis of the optical system, but this is not absolutely necessary. The movement of the optical system typically involves a linear movement or displacement of the optical system in the direction of its optical axis. If the optical system is a focusing optical system, the displacement can be used in particular to displace the focus position of a light beam or a laser beam from a focal plane. A displacement of the optical system achieved with the help of such an apparatus is advantageous for various applications and can also be used to replace an F-theta lens that would otherwise be required in marking applications.

One advantage of the apparatus described above, in which the linear movement of the optical system is achieved by using two concentrically arranged, usually symmetrically designed plate springs, is that the movement of the optical system can be achieved in an almost wear-free manner. However, this is not the case when the movement of the optical system is achieved, for example, by means of ball guides, since these have a limited service life and require lubrication. In principle, other mechanisms for rapidly moving an optical system are also known.

EP3650161A1 describes a focusing device for focusing a laser beam for machining a workpiece. The focusing device comprises an optical device designed to guide the laser beam, and a holding element on which the optical apparatus is arranged. A connecting element is elastically connected to the retaining element by means of several essentially parallel first spring elements. A base element is elastically connected to the connecting element by means of several essentially parallel second spring elements. The focusing device comprises a moving coil drive.

EP2372429A1 describes a drive module which, like EP2099030A1, has two flat springs. The drive module uses a wire made of a shape memory alloy as its drive mechanism.

### SUMMARY

In an embodiment, the present disclosure provides an apparatus for moving an optical system includes a main body, a supporting body to which the optical system is attached, a drive, a first plate spring, and a second plate spring. The drive moves the supporting body relative to the main body along a longitudinal axis of the supporting body. The first plate spring is fastened, in an outer region, to the main body and, in an inner region, to a first side of the supporting body. The second plate spring is fastened, in an outer region, to the main body and, in an inner region, to a second side of the supporting body. The outer region and the inner region of the first plate spring and the outer region and the inner region of the second plate spring are each connected to one another via a plurality of arms which extend in the circumferential direction. At least two of the arms overlap at least partly in the circumferential direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an apparatus for moving an optical system, having a main body and a supporting body, in a perspective view, according to an embodiment of the present disclosure;

FIG. 2 shows a schematic representation of the apparatus analogous to FIG. 1, according to an embodiment of the present disclosure;

FIG. 3 shows a schematic representation of a plate spring of the apparatus shown in FIG. 1 and FIG. 2, according to an embodiment of the present disclosure;

FIG. 4 shows a schematic representation of the apparatus with a measuring device for measuring a displacement of the supporting body relative to the main body, according to an embodiment of the present disclosure;

FIG. 5a, and FIG. 5b show schematic representations of a first partial body of the supporting body, which has an end face for fastening the optical system, according to an embodiment of the present disclosure; and

FIG. 6 shows a schematic sectional view of the supporting body with the first partial body and with a second partial body, according to an embodiment of the present disclosure.

### DETAILED DESCRIPTION

The present disclosure includes an apparatus for moving an optical system and a laser machining device for machining a workpiece, in particular to realize these in a compact design.

According to a first aspect, an apparatus of the type mentioned above, in which at least two of the arms, in particular all arms, overlap at least partly in the circumferential direction.

The circumferential direction and the radial direction (see below) each refer to the center of the plate spring. The at least partial overlap of the at least two arms in the circumferential direction describes the fact that the at least two arms each have at least one section in which these two arms run in a common angular range with respect to the center of the plate spring. In this section, one of the two adjacent arms runs radially inwards, while the other arm runs radially outwards.

The arms are typically curved or spiral in shape. In the first case, the arms maintain a substantially constant distance from the center of the plate spring. In the second case, the distance from the arms to the center of the plate spring changes in the circumferential direction, i.e., the arms extend both circumferentially and radially. The arms serve as bending arms and connect the inner region with the outer region of the plate spring. The arms typically do not branch. The longitudinal axis of the supporting body and typically also the optical axis of the optical system usually run through the center of the respective plate spring.

The plate springs are flat in a non-deflected rest position and bend when the supporting body moves out of the rest position. The partial overlap of the arms in the circumferential direction increases the bending component of the plate springs of the apparatus according to the present disclosure compared to the plate springs described in EP2099030A1, in which the arms are arranged in different angular ranges in the circumferential direction. Furthermore, the plate springs of the present disclosure exhibit larger bending components than similarly sized plate springs, such as those described in EP1643284B1. With the same dimensions of the plate springs, the supporting body and thus also the optical system can be moved over a greater distance in the longitudinal direction than is the case with the plate or plate springs described therein. Accordingly, in the apparatus according to the present disclosure smaller dimensioned plate springs can be used to move the optical system by the same distance.

The inner region of each plate spring typically has a ring-shaped opening. The opening in the inner region of the plate spring is needed if a light beam or a laser beam is to pass through the plate spring. The opening is also necessary if the optical system is to be attached in the center of the plate spring. It is advantageous if the opening, or the optical system attached in the region of the opening, is relatively small in relation to the overall size of the plate spring.

In one embodiment of the present disclosure, each arm has a section adjoining the outer region which overlaps in the circumferential direction with a section of an adjacent arm adjoining the inner region. Such a circumferential overlap has proven advantageous for realizing arms with long bending sections.

In one embodiment of the present disclosure, the arms of the respective plate spring are arranged cyclically symmetrically with respect to the center of the plate spring. The plate spring can, for example, have two, three, four, five, . . . arms that are arranged cyclically symmetrically, i.e., uniformly distributed in the circumferential direction, around the center of the plate spring. When the plate spring is deflected, the cyclically symmetrical arrangement of the arms causes a rotational compensating movement of the center of the plate spring, which causes a rotation of the optical system about its optical axis. A rotation about the optical axis is less critical with regard to beam guidance, in particular in rotationally symmetric optical systems, for example a spherically shaped lens, than a displacement of the optical axis of the optical system in the radial direction.

In an embodiment of the present disclosure, two adjacent arms of the plate springs are separated from one another by a slot, which preferably terminates in widened end sections. The slots extend in the circumferential direction of the respective plate spring and can also extend in a radial direction if the arms are spiral-shaped. The tapering of the slots into widened, e.g., teardrop-shaped end sections serves to reduce notch stresses that can occur at the end sections of the slots when the plate springs bend or deflect.

In an embodiment of the present disclosure, the apparatus comprises a first preferably plate-shaped pressure element for pressing the outer surface of the first plate spring against the main body and a second preferably plate-shaped pressure element for pressing the outer surface of the second plate spring against the main body. The pressure elements are preferably designed as pressure plates that press a respective outer surface of the plate spring against the main body to ensure that the outer surface of the plate spring remains flat and a defined bending of the plate spring occurs. The pressure elements also prevent possible misorientation of the plate spring.

In a further development of this embodiment, the outer regions of the first plate spring and the second plate spring are designed as closed parts, and the first pressure element is designed to press the outer region of the first plate spring against the main body in the circumferential direction, and the second pressure element is designed to press the outer region of the second plate spring against the main body in the circumferential direction. A closed outer region is understood to mean that the outer region is ring-shaped (but not necessarily circular) and has a continuous circumferential edge which is not interrupted by grooves as in EP2099030A1. The outer region, or more precisely the surrounding edge of the outer region, is usually not circular but has the geometry of a polygon, for example a rectangle or a square. The two pressure elements can, for example, be plate-shaped and have a ring-shaped, protruding circumferential edge whose geometry corresponds to the geometry of the edge of the plate spring. In this case, the edge of the pressure elements lies flat against the outer surface of the respective plate spring and presses it against the main body.

In an embodiment of the present disclosure, on the first or the second side, the supporting body has a ring-shaped mounting region for the optical system which is preferably attached via connecting webs to a ring-shaped fastening region for fastening the inner region of the first or the second plate spring. The optical system can, in principle, be fastened at any position along the longitudinal axis of the supporting body, but it is usually advantageous if the optical system is fastened to one of the two sides of the supporting body. The optical system is fixed in the ring-shaped mounting region, for example by gluing the optical system, e.g., in the form of a lens or a lens assembly, to the mounting region at its circumferential edge.

The material of the optical system typically has a coefficient of thermal expansion that differs from the coefficient of thermal expansion of the supporting body. Mechanical stresses can therefore occur when the optical system heats up during operation. In order to reduce these mechanical stresses, it has proven advantageous to connect the mounting region, and thus the optical system, to a radially external fastening region via connecting webs, which typically run in a radial direction, at which the inner region of one of the two plate springs is fastened to one of the two sides of the supporting body. To reduce mechanical stresses, the connecting webs are typically arranged at equal intervals in the circumferential direction.

In an embodiment of the present disclosure, the supporting body is designed as a hollow body, which has a jacket connecting the first side of the supporting body to the second side of the supporting body, wherein at least one opening is preferably formed in the jacket. Using a supporting body in the form of a hollow body allows for a reduction in the weight of the supporting body. Reducing weight is advantageous in order to achieve the fastest possible linear movement of the optical system. The openings in the jacket of the supporting body also serve to reduce the weight of the supporting body. The jacket can have one, two, or more openings or windows. Openings or cutouts can also be provided on the (front) sides of the supporting body to reduce the weight of the supporting body.

In an embodiment of the present disclosure, the drive comprises a first and a second drive element, wherein the first drive element, which preferably has a coil or is designed as a coil, is attached to the supporting body and the second drive element, which preferably has a magnet or is designed as a magnet, is attached to the main body, wherein the first drive element and the second drive element can be displaced relative to one another by a preferably magnetic interaction. The drive with the two drive elements can be designed as a moving coil drive or in another manner.

In a further development of this embodiment, the first drive element and preferably the second drive element run inside the supporting body designed as a hollow body. By arranging the two drive elements inside the supporting body, the apparatus can be realized in a particularly compact design. If the first drive element is a coil, it is typically attached to one of the two (end) sides of the supporting body. In the event that the second drive element is a (permanent) magnet, it is attached to the main body in the region of the other (front) side of the supporting body.

In a further development of this embodiment, the main body has a main body section for attaching the second drive element, which projects into the interior of the hollow body through an opening in the jacket of the hollow body. In this case, the main body section protrudes into the interior of the hollow body in order to be able to arrange the second drive element inside the hollow body. As described above, the second drive element can be a (permanent) magnet that extends from the main body section in the longitudinal direction of the supporting body and overlaps the (diving) coil in the longitudinal direction.

In an embodiment of the present disclosure, the supporting body is formed in several parts. A two-part or multi-part design of the supporting body is advantageous or necessary in order to arrange the second drive element inside the supporting body. For example, in this case, the (front) side of the supporting body, which is adjacent to the main body section, can form a first partial body of the supporting body, and the jacket and the other side of the supporting body can form a second partial body of the supporting body. The two or more partial bodies of the supporting body are preferably detachably connected to one another, for example via a screw connection or the like, but can also be connected to one another via a permanent connection.

In an embodiment of the present disclosure, the supporting body can be deflected along its longitudinal direction relative to the main body in a range of at least +/−1 mm, preferably at least +/−1.5 mm, about a rest position of the supporting body in which the first plate spring and the second plate spring are not deflected. Embodiments with a deflection in this region of up to +/−5 mm are also conceivable. Deflections within this value range can be achieved quickly and with high precision using the apparatus described here.

In an embodiment of the present disclosure, the apparatus comprises a measuring device for measuring a displacement of the supporting body in the longitudinal direction relative to the main body, wherein the measuring device preferably comprises a glass scale and, for example, an optical sensor. The displacement or displacement path can be determined with the help of the measuring device with an accuracy in the order of micrometers. The incrementally coded glass rod, for example, can be attached to the supporting body, usually to the jacket of the supporting body. The sensor is typically attached to the main body and is therefore stationary. Alternatively, other measuring devices can be used, for example a magnetic sensor in combination with a magnetic tape or the like.

The present disclosure also relates to a laser machining device for machining a workpiece, comprising: an apparatus for moving an optical system, which is designed as described above. If the optical system is focusing optical system, the apparatus can be used, for example, to quickly change the focus position of the laser beam in the direction of the laser beam, which is advantageous for marking applications, for example. It goes without saying that the apparatus can also be used for applications other than marking and does not necessarily have to be used in a laser machining device.

Further advantages of the present disclosure are evident from the description and the drawing. Likewise, the features mentioned above and those yet to be presented may be used in each case alone or jointly in any desired combinations. The embodiments shown and described should not be understood as an exhaustive list, but rather are of exemplary character for describing the present disclosure.

In the following description of the drawings, identical reference signs are used for identical or functionally identical components.

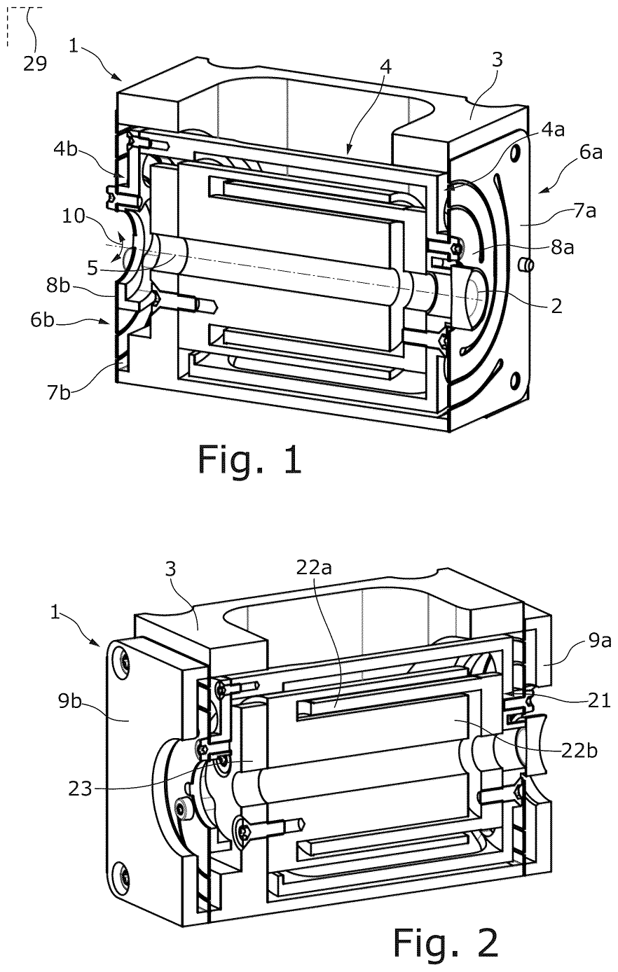

FIG. 1 shows an apparatus 1 in the form of a module for moving an optical system 2, which in the example shown is designed as a focusing lens. The apparatus 1 comprises a main body 3 in the form of a housing, which is stationary, and a supporting body 4 to which the optical system 2 is attached. The supporting body 4 can be moved, more precisely can be linearly displaced, relative to the main body 3 along its longitudinal axis 5, shown in FIG. 1 in dashed lines.

The apparatus 1 has a first plate spring 6a, which is fastened to the main body 3 of the apparatus 1 in an outer region 7a and which is fastened to a first (front) side 4a of the supporting body 4 in an inner region 8a. A second plate spring 6b of the apparatus 1 is fastened in an outer region 7b to the main body 3 and in an inner region 8b to a second (front) side 4b of the supporting body 4. The two plate springs 6a, 6b are aligned parallel to one another and perpendicular to the longitudinal direction 5 of the supporting body 4 in a non-displaced rest position.

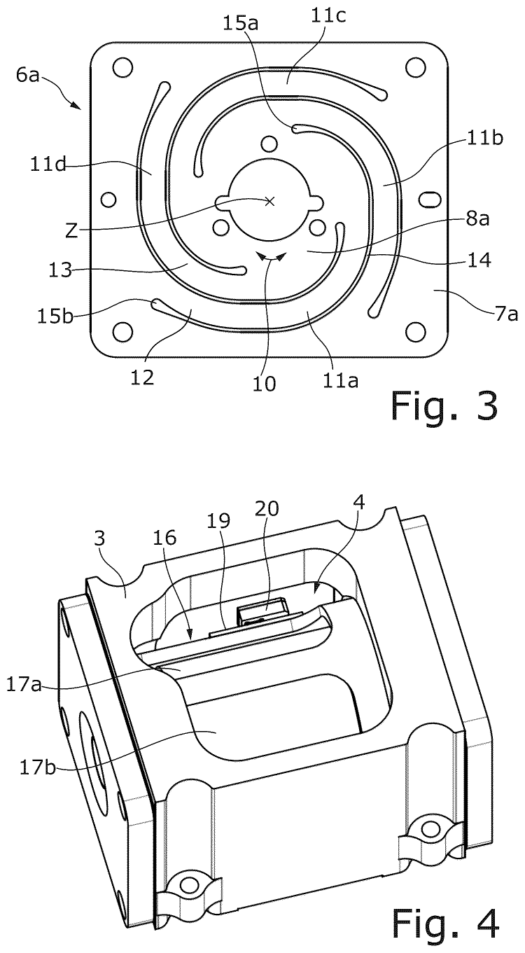

As can be seen in FIG. 2, the apparatus 1 has a first plate-shaped pressure element 9a for pressing the outer surface 7a of the first plate spring 6a against the main body 3 and a second plate-shaped pressure element 9b for pressing the outer surface 7b of the second plate spring 6b against the main body 3. The outer surfaces 7a, 7b of the first plate spring 6a and the second plate spring 6b are designed to be ring-shaped and closed, as can be seen in FIG. 3.

The first plate-shaped pressure element 9a is designed to press the outer surface 7a of the first plate spring 6a against the main body 3 in the circumferential direction 10 (see FIG. 1). For this purpose, the first plate-shaped pressure element 9a has a circumferential outer edge that extends in the longitudinal direction of the supporting body 4. As can also be seen in FIG. 2, the first plate-shaped pressure element 9a is screwed to the main body 3 and the outer surface 7a of the first plate spring 6a is clamped between the first pressure element 9a, more precisely its circumferential edge, and the main body 3 and pressed flat against the main body 3. The second plate-shaped pressure element 9b is designed accordingly, and presses the outer surface 7b of the second plate spring 6b flat against the main body 3 in the circumferential direction 10. The plate-shaped pressure elements 9a, 9b stabilize the respective plate spring 6a, 6b in addition to fastening the outer surface 7a, 7b to the main body 3, which takes place via a screw connection.

FIG. 3 shows the first plate spring 6a of the apparatus 1 of FIG. 1 and FIG. 2 in a plan view. The second plate spring 6b is identical in construction to the first plate spring 6a. As can be seen in FIG. 3, the outer region 7a of the first plate spring 6a is connected to the inner region 8a of the first plate spring 6a via four arms 11a-11d which extend in the circumferential direction 10, which serve as bending arms. Each arm 11a-11d is arc-shaped and extends substantially in the circumferential direction 10 with respect to a center Z of the first plate spring 6a, i.e., each arm 11a-11d has a substantially constant distance in the radial direction to the center Z of the first plate spring 6a. However, this is not absolutely necessary, i.e., the distance in the circumferential direction can also vary, so that the arms 11a-11d run in a spiral shape.

As can also be seen in FIG. 3, two of the arms 11a, 11b; 11b, 11c; 11c, 11d; 11d, 11a overlap partly in the circumferential direction 10. More precisely, each arm 11a-11d, for example the first arm 11a, has a section 12 adjoining the outer region 7a of the first plate spring 6a, which overlaps in the circumferential direction 10 with a section 13 adjoining the inner region 8a of an adjacent arm 11a-11d, which in the example shown is the fourth arm 11d. The four arms 11a-11d are arranged cyclically symmetrically with respect to the center Z of the respective plate spring 6a, 6b. Each pair of adjacent arms 11a, 11b; 11b, 11c; 11c, 11d; 11d, 11a of the plate springs 6a, 6b are separated from one another by a slot 14 which terminates in two widened end sections 15a, 15b in order to reduce a notch effect when the plate springs 6a, 6b are deflected. The two widened end sections 15a, 15b are teardrop-shaped in the example shown.

As can be seen in FIG. 4, the supporting body 4 is designed as a hollow body and has a substantially cylindrical jacket 16 which connects the first side 4a of the supporting body 4 with the second side 4b of the supporting body 4. As also shown in FIG. 4, two large openings 17a, 17b are formed in the jacket 16, which serve to reduce the weight of the supporting body 4. The supporting body 4 can be deflected along its longitudinal axis 5 relative to the main body 3 in a range of at least +/−1 mm, usually at least +/−1.5 mm, about a rest position of the supporting body 4 in which the first plate spring 6a and the second plate spring 6b are not deflected. For measuring the deflection or displacement of the supporting body 4 relative to the main body 3, the apparatus 1 has a measuring device 18, which in the example shown comprises a glass scale 19 which is attached to the supporting body 4, more precisely to the jacket 16 of the supporting body 4. The measuring device 18 also has an optical sensor 20 for detecting the glass scale 19 attached to the main body 3.

To generate the linear movement of the supporting body 4 relative to the main body 3, the apparatus 1 has a drive 21, which in the example shown is designed as a moving coil drive. The drive 21 comprises a first drive element 22a and a second drive element 22b (see FIG. 2). The first drive element 22a is designed as a coil and is attached to the supporting body 4. The second drive element 22b is designed as a permanent magnet and is attached to the main body 3. The first drive element 22a and the second drive element 22b—as is usual with moving coil drives—can be displaced relative to one another by a magnetic interaction, wherein the displacement takes place along the longitudinal axis 5 of the supporting body 4.

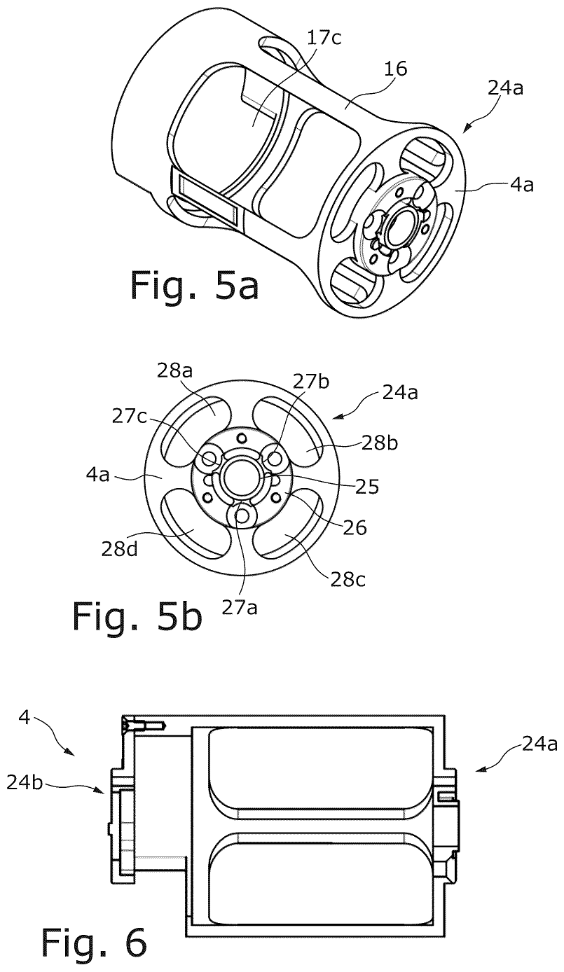

As shown in FIG. 2, the two drive elements 22a, 22b run inside the supporting body 4, which is designed as a hollow body. The first drive element 22a in the form of the coil is fastened to the inside of the first end face 4a of the supporting body 4. The second drive element 22b, in the form of the permanent magnet, is attached to a projecting main body section 23 of the main body 3, which protrudes into the interior of the supporting body 4 through an opening 17c in the jacket 16 of the supporting body 4, shown in FIG. 5a.

The supporting body 4 in the example shown is of multi-part design, more precisely two-part design, and comprises a first partial body 24a and a second partial body 24b. The first partial body 24a, which is shown in FIG. 5a and in FIG. 5b comprises the jacket 16 and the first side 4a of the supporting body 4; in the example shown, the second partial body 24b consists of the second side 4b of the supporting body 4 and is fastened, more precisely screwed, to the jacket 16 of the first partial body 24a, as can be seen in FIG. 6. The multi-part design of the supporting body 4 is necessary to enable the attachment of the second drive element 22b to the protruding main body section 23.

As can be seen in FIG. 5b, on the first side 4a the supporting body 4, more precisely the first partial body 24a, has a ring-shaped mounting region 25 for fastening the optical system 2 in the form of the focusing lens. The optical system 2 is permanently connected to the supporting body 4 in the mounting region 25. In the example shown, the optical system 2 is glued to the mounting region 25. The mounting region 25 is surrounded in a radial direction by a ring-shaped fastening region 26, which serves to fasten the inner region 8a of the first plate spring 6a and which for this purpose projects slightly beyond the remaining end face 4a of the supporting body 4. The mounting region 25 is connected to the fastening region 26 via three radially extending connecting webs 27a-27c. The connecting webs 27a-27c are arranged at equal intervals along the circumference and separated from one another by elongated holes. The connecting webs 27a-27c each form a section of a conical opening in the fastening region 26. As can also be seen in FIGS. 5a, 5b, the first side 4a of the supporting body 4 has four further openings 28a-28d to further reduce the weight of the supporting body 4.

The apparatus 1 described above can be used in different optical systems, for example in a laser machining device 29 for machining, for example for marking, a workpiece, which is indicated by dashed lines in FIG. 1. In such a laser machining device 29, the apparatus can be used, for example, as a focusing device which enables a rapid displacement of the focus position of the laser beam from a focal plane near which the workpiece is typically located. In order to allow the laser beam to pass through the apparatus 1, it has a through channel as shown in FIG. 1, which extends from the first side 4a of the supporting body 4 to the second side 4b of the supporting body 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An apparatus for moving an optical system, comprising:
a main body;
a supporting body to which the optical system is attached;
a drive for moving the supporting body relative to the main body along a longitudinal axis of the supporting body;
a first plate spring which is fastened, in an outer region, to the main body and, in an inner region, to a first side of the supporting body; and
a second plate spring which is fastened, in an outer region, to the main body and, in an inner region, to a second side of the supporting body, wherein the outer region and the inner region of the first plate spring and the outer region and the inner region of the second plate spring are each connected to one another via a plurality of arms which extend in a circumferential direction, and
wherein
at least two of the plurality of arms overlap at least partly in the circumferential direction.

2. The apparatus according to claim 1, wherein each arm of the plurality of arms has a section adjoining the outer region of the first plate spring which overlaps in the circumferential direction with a section of an adjacent arm of the plurality of arms adjoining the inner region of the first plate spring.

3. The apparatus according to claim 1, wherein the plurality of arms are arranged cyclically symmetrically with respect to a center of each of the respective plate springs.

4. The apparatus according to claim 1, wherein each pair of adjacent arms of the plurality of arms of the first plate spring and the second plate spring are separated from one another by a slot.

5. The apparatus according to claim 1, further comprising:
a first plate-shaped pressure element for pressing the outer surface of the first plate spring against the main body and a second plate-shaped pressure element for pressing the outer surface of the second plate spring against the main body.

6. The apparatus according to claim 5, wherein the outer regions of the first plate spring and the second plate spring are designed as closed parts, wherein the first pressure element is designed to press the outer region of the first plate spring against the main body in the circumferential direction, and wherein the second pressure element is designed to press the outer region of the second plate spring against the main body in the circumferential direction.

7. The apparatus according to claim 1, wherein, on the first side or the second side, the supporting body has a ring-shaped mounting region for the optical system.

8. The apparatus according to claim 1, wherein the supporting body is designed as a hollow body having a jacket connecting the first side of the supporting body to the second side of the supporting body.

9. The apparatus according to claim 1, wherein the drive comprises a first and a second drive element, wherein the first drive element is attached to the supporting body and the second drive element is attached to the main body, and wherein the first drive element and the second drive element can be displaced relative to one another by a magnetic interaction.

10. The apparatus according to claim 9, wherein the first drive element and the second drive element run inside the supporting body designed as a hollow body.

11. The apparatus according to claim 10, wherein the main body has a main body section for attaching the second drive element which projects into an interior of the supporting body through an opening in a jacket of the supporting body.

12. The apparatus according to claim 1, wherein the supporting body is formed in several parts.

13. The apparatus according to claim 1, wherein the supporting body can be deflected along its longitudinal axis relative to the main body in a range of at least +/−1 mm about a rest position of the supporting body in which the first plate spring and the second plate spring are not deflected.

14. The apparatus according to claim 1, further comprising:
a measuring device for measuring a displacement of the supporting body relative to the main body.

15. A laser machining device for machining a workpiece, comprising:
an apparatus for moving an optical system according to claim 1.

16. The apparatus according to claim 1, wherein each pair of adjacent arms of the plurality of arms of the first plate spring and the second plate spring are separated from one another by a slot which terminates in widened end sections.

17. The apparatus according to claim 1, wherein, on the first side or the second side, the supporting body has a ring-shaped mounting region for the optical system which is attached via connecting webs to a ring-shaped fastening region for fastening the inner region of the first plate spring or the second plate spring.

18. The apparatus according to claim 8, wherein at least one opening is formed in the jacket.

19. The apparatus according to claim 9, wherein the first drive element has a coil, and wherein the second drive element has a magnet.

20. The apparatus according to claim 1, wherein the supporting body can be deflected along its longitudinal axis relative to the main body in a range of at least +/−1.5 mm about a rest position of the supporting body in which the first plate spring and the second plate spring are not deflected.
